(19) United States
(12) Patent Application Publication
(10) Pub. No.: US 2025/0330612 A1
(43) Pub. Date: Oct. 23, 2025

(54) EXTRAPOLATION FILTER BASED INTRA PREDICTION

(71) Applicant: Tencent America LLC, Palo Alto, CA (US)

(72) Inventors: Madhu PERINGASSERY KRISHNAN, Mountain View, CA (US); Xiaozhong XU, State College, CA (US); Roman CHERNYAK, Santa Clara, CA (US); Xin ZHAO, San Jose, CA (US); Shan LIU, San Jose, CA (US)

(73) Assignee: Tencent America LLC, Palo Alto, CA (US)

(21) Appl. No.: 19/258,782

(22) Filed: Jul. 2, 2025

Related U.S. Application Data
(63) Continuation of application No. PCT/US2024/025575, filed on Apr. 19, 2024.
(60) Provisional application No. 63/460,886, filed on Apr. 20, 2023.

(51) Int. Cl. H04N 19/14; H04N 19/159; H04N 19/176

(52) U.S. Cl. CPC H04N 19/14; H04N 19/159; H04N 19/176

(57) ABSTRACT

Methods and apparatuses for video decoding and video encoding and a method of processing visual media data are described. The apparatus for video decoding comprises processing circuitry configured to: receive predicted information indicating that a current block in a current picture is predicted using an extrapolation filter-based intra prediction (EIP) mode; determine gradient information associated with a current sample in the current block; determine a predicted value of the current sample based on an initial predicted value predicted using the EIP mode and additional information that includes the gradient information; and reconstruct the current sample from the predicted value of the current sample.

### RELATED APPLICATION

The present application is a continuation of International Application No. PCT/US2024/025575, filed on Apr. 19, 2024, which claims the benefit of priority to U.S. Provisional Application No. 63/460,886, “Improvement of extrapolation filter based intra prediction” filed on Apr. 20, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data comprises performing a conversion between a visual media file and a bitstream of visual media data according to a format rule where the bitstream includes prediction information indicating that a current block in a current picture is predicted using an extrapolation filter-based intra prediction (EIP) mode. The format rule specifies that gradient information associated with a current sample in the current block that is predicted using the EIP mode is determined; a nonlinear value associated with the current sample is determined from neighboring samples of the current sample using a nonlinear relationship between the nonlinear value and values of the neighboring samples; a predicted value of the current sample is determined from an initial predicted value predicted based on the EIP mode, the gradient information, and the nonlinear value; when the gradient information includes horizontal gradient information, a number of first input samples used to determine the horizontal gradient information and positions of the first input samples are set independently from a number and positions of input samples used to determine the initial predicted value; when the gradient information includes vertical gradient information, a number of second input samples used to determine the vertical gradient information and positions of the second input samples are set independently from the number and the positions of the input samples used to determine the initial predicted value; and when the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value, respectively.

In an example, the gradient information includes a sum of the horizontal gradient information and the vertical gradient information; and the number of the first input samples is equal to the number of the second input samples.

In an example, one of (i) the number of the first input samples used to determine the horizontal gradient information of the gradient information or the positions of the first input samples and (ii) the number of the second input samples used to determine the vertical gradient information of the gradient information or the positions of the second input samples depends on a block shape of the current block or a filter shape of the EIP mode.

In an example, the determining the gradient information comprises determining the gradient information based on at least one of (i) the horizontal gradient information that is determined based on horizontal gradients of the respective first input samples and (ii) the vertical gradient information that is determined based on vertical gradients of the respective second input samples.

In an example, a horizontal gradient of one of the first input samples is determined based on: (i) a difference between the one of the first input samples and a left neighbor of the one of the first input samples; (ii) a difference between the left neighbor of the one of the first input samples and a right neighbor of the one of the first input samples; and (iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples.

In an example, which of the differences is used to calculate the horizontal gradient of the one of the first input samples is determined based on a position of the one of the first input samples.

In an example, a vertical gradient of one of the second input samples is determined based on: (i) a difference between the one of the second input samples and a top neighbor of the one of the second input samples; (ii) a difference between the top neighbor of the one of the second input samples and a bottom neighbor of the one of the second input samples; and (iii) a difference between a first value and a second value, the first value being a sum based on a top-left neighbor, the top neighbor, and a top-right neighbor of the one of the second input samples, the second value being a sum based on bottom-left neighbor, the bottom neighbor, and a bottom-right neighbor of the one of the second input samples.

In an example, which of the differences is used to calculate the vertical gradient of the one of the second input samples is determined based on a position of the one of the second input samples.

In an aspect, a method for video encoding comprises: determining gradient information associated with a current sample in a current block that is predicted using an extrapolation filter-based intra prediction (EIP) mode; determining a nonlinear value associated with the current sample from neighboring samples of the current sample based on a nonlinear relationship between the nonlinear value and values of the neighboring samples; and determining a predicted value of the current sample based on an initial predicted value predicted using the EIP mode, the gradient information, and the nonlinear value.

In an example, when the gradient information includes horizontal gradient information, a number of first input samples used to determine the horizontal gradient information and positions of the first input samples are set independently from a number and positions of input samples used to determine the initial predicted value; when the gradient information includes vertical gradient information, a number of second input samples used to determine the vertical gradient information and positions of the second input samples are set independently from the number and the positions of the input samples used to determine the initial predicted value; and when the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value.

In an example, the gradient information includes a sum of the horizontal gradient information and the vertical gradient information; and the number of the first input samples is equal to the number of the second input samples.

In an example, one of (i) a number of first input samples used to determine horizontal gradient information of the gradient information or positions of the first input samples and (ii) a number of second input samples used to determine vertical gradient information of the gradient information or positions of the second input samples depends on a block shape of the current block or a filter shape of the EIP mode.

In an example, the determining the gradient information comprises determining the gradient information based on at least one of the horizontal gradient information that is determined based on horizontal gradients of the respective first input samples or the vertical gradient information that is determined based on vertical gradients of the respective second input samples.

In an example, a horizontal gradient of one of the first input samples is determined based on: (i) a difference between the one of the first input samples and a left neighbor of the one of the first input samples; (ii) a difference between the left neighbor of the one of the first input samples and a right neighbor of the one of the first input samples; and (iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples.

In an example, which of the differences is used to calculate the horizontal gradient of the one of the first input samples is determined based on a position of the one of the first input samples.

In an example, a vertical gradient of one of the second input samples is determined based on: (i) a difference between the one of the second input samples and a top neighbor of the one of the second input samples; (ii) a difference between the top neighbor of the one of the second input samples and a bottom neighbor of the one of the second input samples; and (iii) a difference between a first value and a second value, the first value being a sum based on a top-left neighbor, the top neighbor, and a top-right neighbor of the one of the second input samples, the second value being a sum based on bottom-left neighbor, the bottom neighbor, and a bottom-right neighbor of the one of the second input samples.

In an example, which of the differences is used to calculate the vertical gradient of the one of the second input samples is determined based on a position of the one of the second input samples.

In aspect, an apparatus for video decoding comprises processing circuitry. The processing circuitry is configured to: receive predicted information indicating that a current block in a current picture is predicted using an extrapolation filter-based intra prediction (EIP) mode; determine gradient information associated with a current sample in the current block; determine a predicted value of the current sample based on an initial predicted value predicted using the EIP mode and additional information that includes the gradient information; and reconstruct the current sample from the predicted value of the current sample.

In an example, the processing circuitry is configured to determine a nonlinear value associated with the current sample from neighboring samples of the current sample based on a nonlinear relationship between the nonlinear value and values of the neighboring samples; and determine the predicted value of the current sample from the initial predicted value predicted using the EIP mode and the additional information that includes the gradient information and the nonlinear value.

In an example, when the gradient information includes horizontal gradient information, a number of first input samples used to determine the horizontal gradient information and positions of the first input samples are set independently from a number and positions of input samples used to determine the initial predicted value; when the gradient information includes vertical gradient information, a number of second input samples used to determine the vertical gradient information and positions of the second input samples are set independently from the number and the positions of the input samples used to determine the initial predicted value; and when the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value.

In an example, the gradient information includes a sum of the horizontal gradient information and the vertical gradient information; and the number of the first input samples is equal to the number of the second input samples.

In an example, one of (i) a number of first input samples used to determine horizontal gradient information of the gradient information or positions of the first input samples and (ii) a number of second input samples used to determine vertical gradient information of the gradient information or positions of the second input samples depends on a block shape of the current block or a filter shape of the EIP mode.

In an example, the processing circuitry is configured to determine the gradient information based on at least one of the horizontal gradient information that is determined based on horizontal gradients of the respective first input samples or the vertical gradient information that is determined based on vertical gradients of the respective second input samples.

In an example, the processing circuitry is configured to determine a horizontal gradient of one of the first input samples based on: (i) a difference between the one of the first input samples and a left neighbor of the one of the first input samples; (ii) a difference between the left neighbor of the one of the first input samples and a right neighbor of the one of the first input samples; and (iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples.

In an example, the processing circuitry is configured to determine which of the differences is used to calculate the horizontal gradient of the one of the first input samples based on a position of the one of the first input samples.

In an example, the processing circuitry is configured to determine a vertical gradient of one of the second input samples based on: (i) a difference between the one of the second input samples and a top neighbor of the one of the second input samples; (ii) a difference between the top neighbor of the one of the second input samples and a bottom neighbor of the one of the second input samples; and (iii) a difference between a first value and a second value, the first value being a sum based on a top-left neighbor, the top neighbor, and a top-right neighbor of the one of the second input samples, the second value being a sum based on a bottom-left neighbor, the bottom neighbor, and a bottom-right neighbor of the one of the second input samples.

In an example, the processing circuitry is configured to determine which of the differences is used to calculate the vertical gradient of the one of the second input samples based on a position of the one of the second input samples.

In an example, the processing circuitry is configured to: calculate a first value that is one of a mean or a median of a top-left neighbor, a top neighbor, and a left neighbor of the current sample; and determine the nonlinear value based on the first value squared.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIG. 4 shows an example of intra prediction modes (e.g., 67 intra prediction modes) according to an aspect of the disclosure.

FIG. 5 shows an example of a matrix weighted intra prediction (MIP) process according to an aspect of the disclosure.

FIG. 6 shows an example of a spatial part of a convolutional filter according to an aspect of the disclosure.

FIG. 7 shows an example of a reference area used to derive filter coefficients according to an aspect of the disclosure.

FIG. 8 shows examples of spatial samples used for a gradient and location based convolutional cross-component model (GL-CCCM) according to an aspect of the disclosure.

FIG. 9 shows examples of three types of reconstructed areas used in an extrapolation filter-based intra prediction (EIP) mode according to an aspect of the disclosure.

FIG. 10 shows examples of three types of filter shapes used in an EIP mode according to an aspect of the disclosure.

FIGS. 11-13 show an example of predicting samples in a current block based on an EIP mode according to an aspect of the disclosure.

FIG. 14 shows an example of input samples used in the EIP filter according to an aspect of the disclosure.

FIG. 15 shows an example of spatial samples of an input sample C used for calculating gradient information according to an aspect of the disclosure.

FIG. 16 shows an example of choosing a gradient calculation method based on a position of an input sample according to an aspect of the disclosure.

FIG. 17 shows an example of locations of neighboring samples of a current sample according to an aspect of the disclosure.

FIG. 18 shows a flow chart outlining a decoding process according to some aspects of the disclosure.

FIG. 19 shows a flow chart outlining an encoding process according to some aspects of the disclosure.

FIG. 20 is a schematic illustration of a computer system in accordance with an aspect.

### DETAILED DESCRIPTION OF EMBODIMENTS

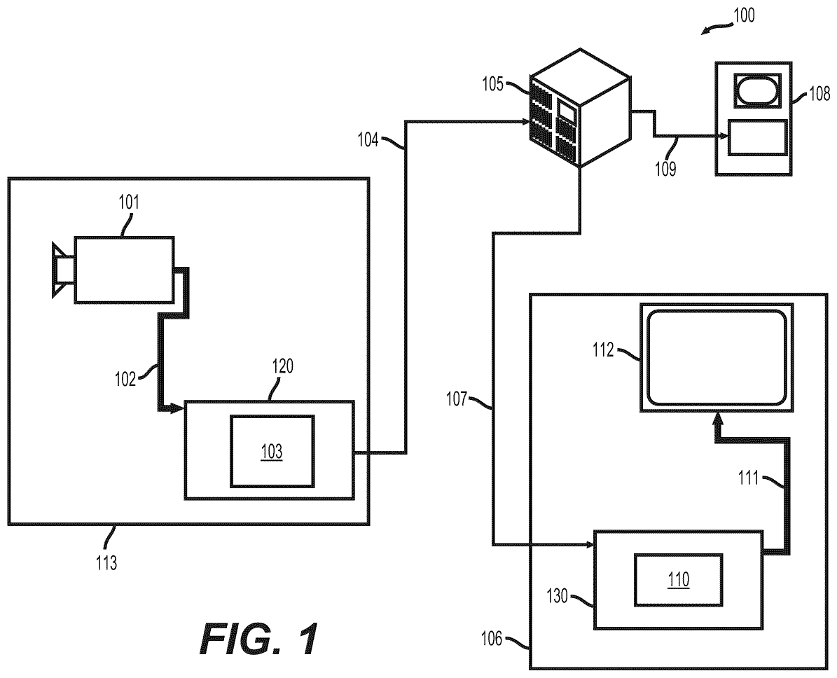

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

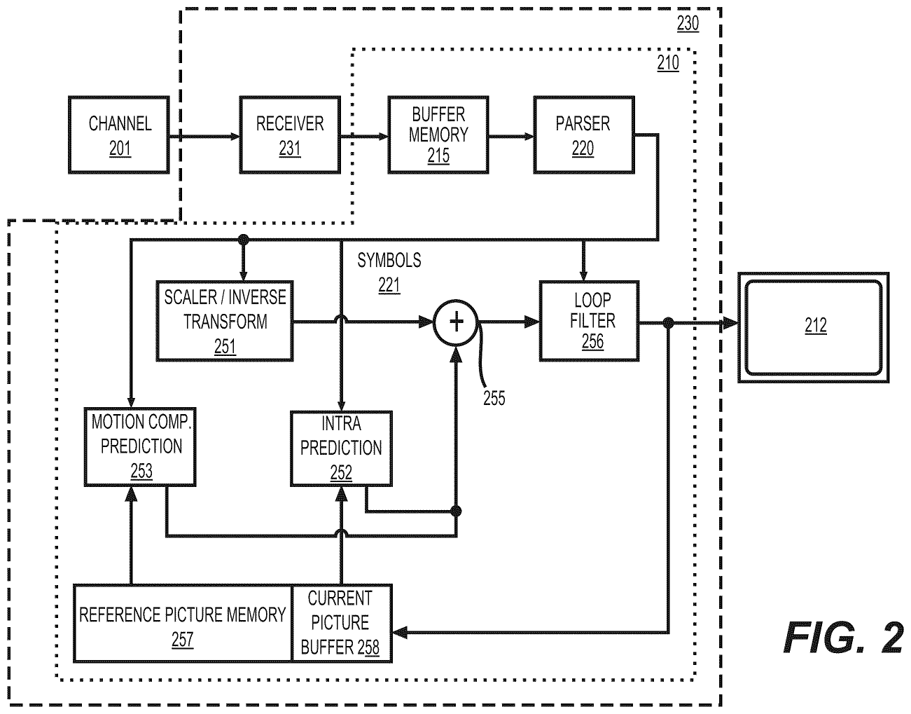

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

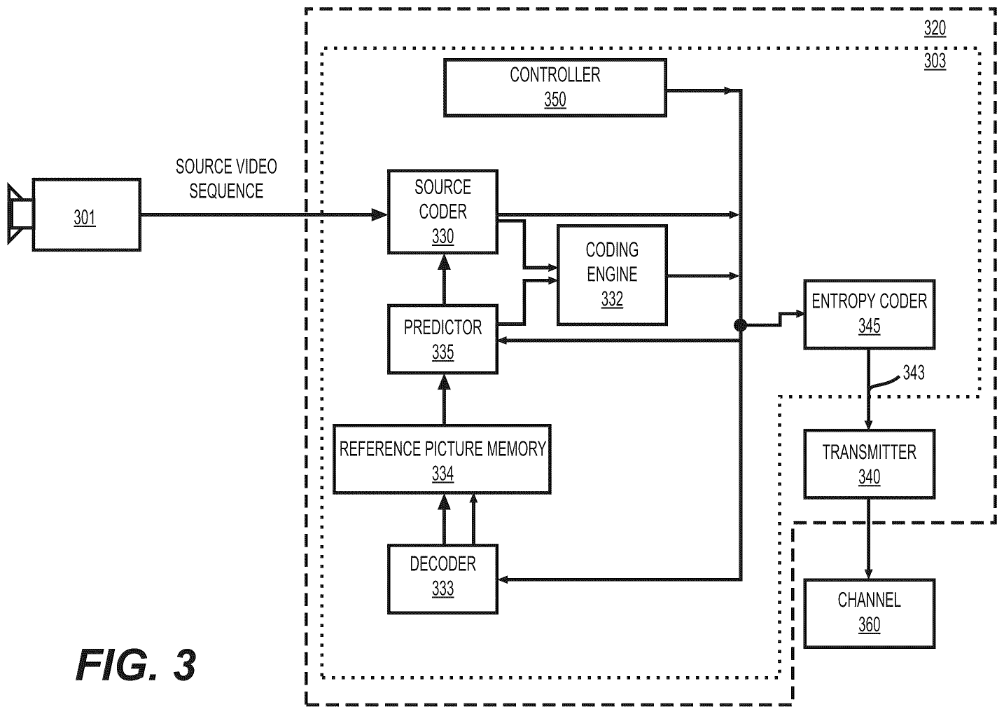

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Intra prediction may be used, such as in VVC. Advanced intra prediction techniques such as used in VVC may include the DC and planar modes similar to HEVC, additional finer-granularity angular prediction with more angles compared to HEVC (e.g., a number of angular prediction modes may be used increased from 33 in HEVC to 93), additional matrix-based prediction modes for a luma component, and cross-component prediction modes for a chroma component. The new (e.g., additional) intra coding tools such as used in VVC may include: 67 intra mode with wide angles mode extension; block size and mode dependent 4 tap interpolation filter; position dependent intra prediction combination (PDPC); cross component linear model (CCLM) intra prediction; multi-reference line (MRL) intra prediction; intra sub-partitions (ISP); and weighted intra prediction with matrix multiplication.

In an example, intra mode coding with 67 intra prediction modes is described as follows. To capture the arbitrary edge directions presented in a natural video, the number of directional intra modes such as used in VVC is extended from 33 as used in HEVC to 65. The new directional modes that are not in HEVC are depicted as dotted arrows in FIG. 4, and the planar and DC modes remain the same. The denser directional intra prediction modes may apply for various block sizes (e.g., all block sizes) and for both luma and chroma intra predictions. In an example, such as in VVC, multiple conventional angular intra prediction modes are adaptively replaced with wide-angle intra prediction modes for the non-square blocks. In an example, the conventional angular intra prediction modes may include the angular intra prediction modes used in HEVC.

In an example, such as in HEVC, an intra-coded block (e.g., every intra-coded block) has a square shape and the length of each side may a power of 2. Thus, no division operations are required to generate an intra-predictor using the DC mode. In an example, such as in VVC, blocks can have a rectangular shape. In some examples, a division operation per block may be used (e.g., may be required). To avoid division operations for the DC prediction, in some examples, only the longer side is used to compute the average for non-square blocks.

An example if intra mode coding is described as follows. To keep the complexity of the most probable mode (MPM) list generation low, an intra mode coding method with 6 MPMs may be used by considering two available neighboring intra modes. The following three aspects may be considered to construct the MPM list: default intra modes; neighbouring intra modes; and derived intra modes. In an example, a unified 6-MPM list is used for intra blocks irrespective of whether MRL and ISP coding tools are applied or not. The MPM list may be constructed based on intra modes of the left and above neighboring blocks of the current block.

In an example, a 4-tap interpolation filter and reference sample smoothing may be applied. Four-tap intra interpolation filters (IF) may be utilized to improve the directional intra prediction accuracy. In HEVC, a two-tap linear interpolation filter has been used to generate the intra prediction block in the directional prediction modes (e.g., excluding Planar and DC predictors). In VVC, in some examples, the two sets of 4-tap IFs may replace lower precision linear interpolation as in HEVC, where one is a DCT-based interpolation filter (DCTIF) and the other one is a 4-tap smoothing interpolation filter (SIF). The DCTIF may be constructed in the same way as the one used for chroma component motion compensation in both HEVC and VVC. The SIF may be obtained by convolving the 2-tap linear interpolation filter with a [1 2 1]/4 filter.

Depending on the intra prediction mode, the following reference samples processing may be performed in some examples:
The directional intra-prediction mode is classified into one of the following groups:
   Group A: vertical or horizontal modes (HOR_IDX, VER_IDX),
   Group B: directional modes that represent non-fractional angles (−14, −12, −10, −6, 2, 34, 66, 72, 76, 78, 80,) and Planar mode,
   Group C: remaining directional modes;
If the directional intra-prediction mode is classified as belonging to the group A, then no filters are applied to reference samples to generate predicted samples;
Otherwise, if a mode falls into the group B and the mode is a directional mode, and all of following conditions are true, then a [1, 2, 1] reference sample filter may be applied (depending on the mode dependent intra smoothing (MDIS) condition) to reference samples to further copy the filtered values into an intra predictor according to the selected direction, but no interpolation filters are applied:
   refIdx is equal to 0 (no MRL)
   TU size is greater than 32
   Luma
   No ISP block
Otherwise, if a mode is classified as belonging to the group C, an MRL index is equal to 0, and the current block is not an ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min(Abs(predModeIntra−50), Abs(predModeIntra−18))
   Set nTbS equal to (Log 2(W)+Log 2(H))>>1
   Set intraHorVerDistThres[nTbS] as specified below:

| | nTbS = | nTbS = | nTbS = | nTbS = | nTbS = | nTbS = |
|---|---|---|---|---|---|---|
| | 2 | 3 | 4 | 5 | 6 | 7 |
| intraHorVerDistThres | 24 | 14 | 2 | 0 | 0 | 0 |
| [nTbS] | | | | | | |

If minDistVerHor is greater than intraHorVerDistThres[nTbS], SIF is used for the interpolation
   Otherwise, DCTIF is used for the interpolation.

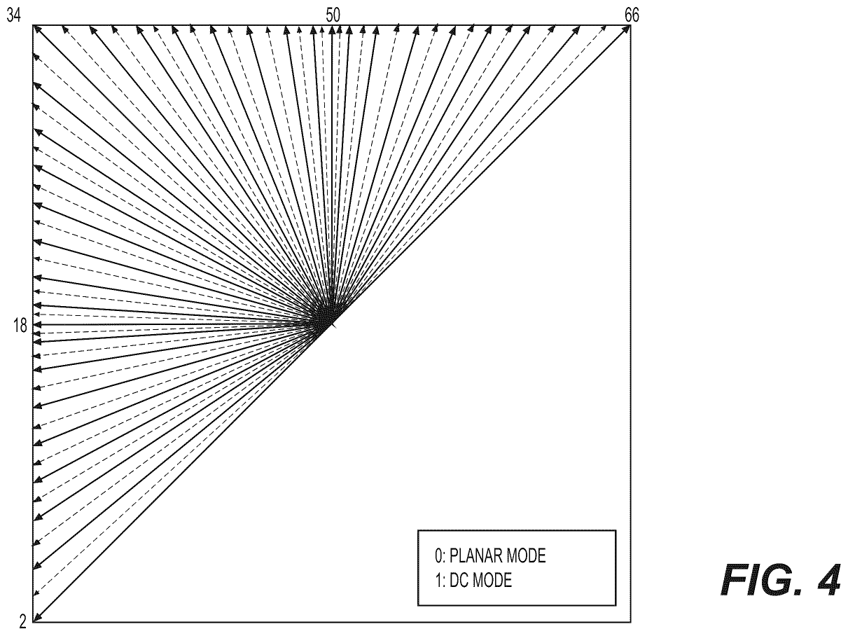

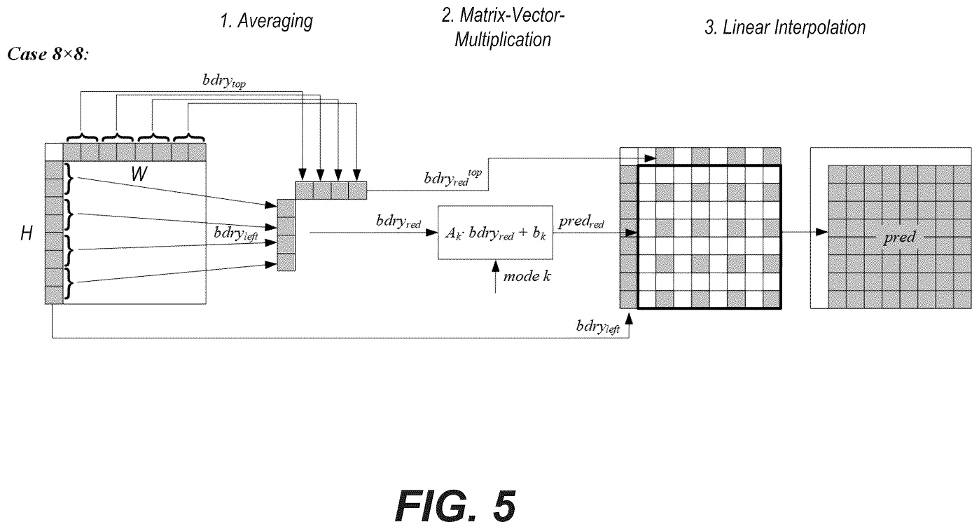

Matrix weighted Intra Prediction (MIP) may be used. The MIP method is a newly added intra prediction technique into VVC. For predicting the samples of a rectangular block of width and height, the MIP mode may takes one line of H reconstructed neighbouring boundary samples to the left of the block and one line of reconstructed neighbouring boundary samples above the block as input. If the reconstructed samples are unavailable, they may be generated as done in the conventional intra prediction. The generation of the prediction signal may be based on the following three steps, including averaging, matrix vector multiplication and linear interpolation as shown in FIG. 5.

Convolutional cross-component intra prediction model may be used such as in ECM. A convolutional cross-component model (CCCM) may be applied to predict chroma samples from reconstructed luma samples in a similarly as done by the current CCLM modes. As with CCLM, the reconstructed luma samples may be down-sampled to match the lower resolution chroma grid when chroma sub-sampling is used. Similar to CCLM, top, left, or top and left reference samples may be used as templates for model derivation.

Similarly to CCLM, there may be an option of using a single model or multi-model variant of CCCM. The multi-model variant may use two models, one model derived for samples above the average luma reference value and another model for the rest of the samples (following the spirit of the CCLM design). Multi-model CCCM mode can be selected for PUs which, for example, have at least 128 reference samples available.

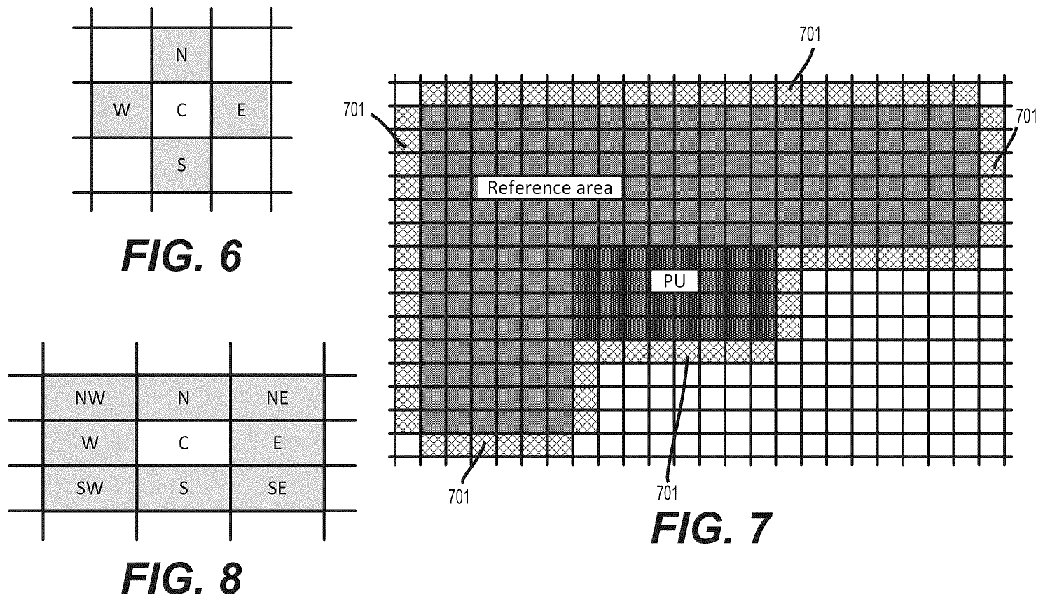

A convolutional filter, such as a convolutional 7-tap filter may include (e.g., consist of) a 5-tap plus sign shape spatial component, a nonlinear term, and a bias term. The input to the spatial 5-tap component of the filter may include (e.g., consist of) a center (C) luma sample which is collocated with the chroma sample to be predicted and its above or north (N), below or south(S), left or west (W) and right or east (E) neighbors as illustrated in FIG. 6.

The nonlinear term NP may be represented as power of two of the center luma sample C and may be scaled to the sample value range of the content such as described in Eq. 1.

$$NP = ( {C}^{2} + midVal ) ≫ bitDepth \qquad Eq . 1$$

That is, for 10-bit content the nonlinear term NP may be calculated using Eq. 2.

$$NP = ( {C}^{2} + 5 \; 12 ) ≫ 10 \qquad Eq . 2$$

The middle value (midVal) is 2¹⁰/2, which is 512.

The bias term B may represent a scalar offset between the input and output (e.g., similar to the offset term in CCLM) and may be set to a middle chroma value (e.g., 512 for 10-bit content).

An output of the filter may be calculated as a convolution between the filter coefficients cᵢ and the input values and may be clipped to the range of valid chroma samples using Eq. 3.

$$pred Chroma Val = {c}_{0} C + {c}_{1} N + {c}_{2} S + {c}_{3} E + {c}_{4} W + {c}_{5} P + {c}_{6} B \qquad Eq . 3$$

The filter coefficients cᵢ may be calculated, for example, by minimizing a mean squared error (MSE) between predicted and reconstructed chroma samples in the reference area. FIG. 7 shows an example of the reference area (with its paddings) used to derive the filter coefficients according to an aspect of the disclosure. The reference area may include (e.g., consist of) 6 lines of chroma samples above and to the left of the PU. The reference area may extend one PU width to the right and one PU height below the PU boundaries. The area may be adjusted to include only available samples. The extensions (701) to the area may be used to support the “side samples” of the plus shaped spatial filter and are padded when in unavailable areas.

The MSE minimization may be performed by a calculating autocorrelation matrix for the luma input and a cross-correlation vector between the luma input and chroma output. Autocorrelation matrix may be LDL decomposed and the final filter coefficients may be calculated using back-substitution. The process follows roughly the calculation of the ALF filter coefficients such as used in ECM, however LDL decomposition was chosen instead of Cholesky decomposition, for example, to avoid using square root operations.

The autocorrelation matrix may be calculated using the reconstructed values of luma and chroma samples. The luma and chroma samples may be in a full range (e.g., between 0 and 1023 for 10-bit content) resulting in relatively large values in the autocorrelation matrix. This may use high bit depth operation during the model parameters calculation. Fixed offsets may be removed from luma and chroma samples in each PU for each model. This may reduce the magnitudes of the values used in the model creation and allow reducing the precision for the fixed-point arithmetic. As a result, in some examples, 16-bit decimal precision may be used instead of the 22-bit precision of the original CCCM implementation.

In some examples, reference sample values just outside of the top-left corner of the PU may be used as the offsets (offsetLuma, offsetCb and offsetCr) for simplicity. The samples values used in both model creation and final prediction (e.g., luma and chroma in the reference area, and luma in the current PU) may be reduced by the fixed values, as follows: C′=C−offsetLuma; N′=N−offsetLuma; S′=S−offsetLuma; E′=E−offsetLuma; W′=W−offsetLuma; P′=nonLinear (C′); B=midValue=1<<(bitDepth−1); and the chroma value be predicted using Eq. 4, where offsetChroma is equal to offsetCr and offsetCb for Cr and Cb components, respectively.

$$pred Chroma Val = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} {B}^{′} + offsetChroma \qquad Eq . 4$$

In an example, to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation, the chroma offset may be added to the bias term of the convolutional model.

The process of CCCM model parameter calculation may use division operations. In some examples, division operations may not be implementation friendly. The division operation may be replaced with multiplication (with a scale factor) and shift operation, where a scale factor and a number of shifts may be calculated based on a denominator, for example, similar to the method used in calculation of CCLM parameters.

A gradient and location based convolutional cross-component model (GL-CCCM) may map luma values into chroma values using a filter with inputs including (e.g., consisting of) one spatial luma sample, two gradient values, two location information, a nonlinear term, and a bias term. The GL-CCCM method may use gradient and location information instead of the 4 spatial neighbor samples used in the CCCM filter. The GL-CCCM filter used for the prediction may be described using Eq. 5.

$$pred Chroma Val = {c}_{0} C + {c}_{1} {G}_{y} + {c}_{2} {G}_{x} + {c}_{3} Y + {c}_{4} X + {c}_{5} P + {c}_{6} B \qquad Eq . 5$$

FIG. 8 shows examples of spatial samples used for the GL-CCCM according to an aspect of the disclosure. Gy and Gx are the vertical and horizontal gradients, respectively, and are calculated using Eq. 6.

$${G}_{y} = ( 2 N + NW + NE ) - ( 2 S + SW + SE ) \qquad Eq . 6$$

$${G}_{x} = ( 2 W + NW + SW ) - ( 2 E + NE + SE )$$

The Y and X are the spatial coordinates of the center luma sample.

The rest of the parameters may be the same as CCCM tool. The reference area for the parameter calculation may be the same as CCCM method.

The usage of the GL-CCCM mode may be signaled with a flag, such as a CABAC coded PU level flag. The GL-CCCM mode may be considered a sub-mode of CCCM in terms of signaling, for example, the GL-CCCM flag is only signaled if the original CCCM flag is true.

Similar to the CCCM, in some examples, the GL-CCCM tool has 6 modes for calculating the parameters: a single-model GL-CCCM from above and left templates; a single-model GL-CCCM from the above template; a single-model GL-CCCM from the left template; a multi-model GL-CCCM from the above and left templates; a multi-model GL-CCCM from the above template; and a multi-model GL-CCCM from the left template. The encoder may perform a search (e.g., a sum of absolute transformed differences (SATD) search) for the 6 GL-CCCM modes along with the existing CCCM modes to find the best candidates for full rate-distortion (RD) tests.

An extrapolation filter-based intra prediction (EIP) mode may be used. In an example, the EIP mode includes two steps. In a first step, the extrapolation filter coefficients may be obtained from the neighboring reconstructed pixels (or samples) of the current block with a pre-determined template. In a second step, the extrapolation may generate a predicted value position by position, for example, from a top-left sample to a bottom-right sample within the current block.

In an example, a mean value, a min value, and a max value may be searched as follows. Similar to the CCCM mode, in the EIP mode, a mean value may be removed when feeding the inputs to the EIP filter. The value of the DC mode for the current block may be used as the mean value for EIP prediction. The min value and the max value may be searched from reconstructed pixels in the reconstructed area with, for example, thirteen columns and thirteen rows.

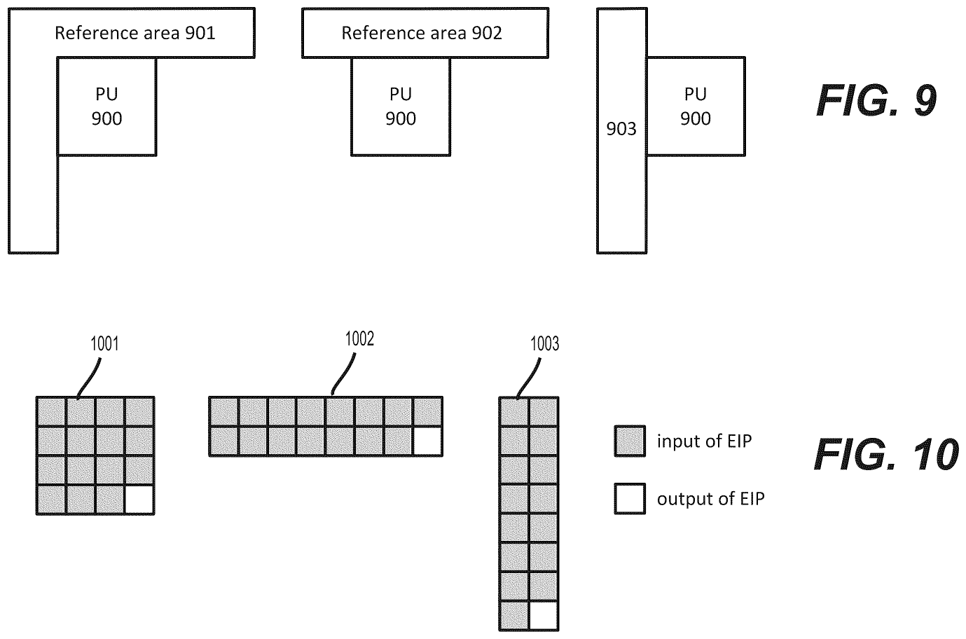

Filter coefficients may be calculated as below. FIG. 9 shows examples of the defined three types of reconstructed areas according to an aspect of the disclosure. The three types of reconstructed areas or the reference areas (901)-(903) may include thirteen columns or rows of reconstructed pixels. FIG. 10 shows examples of the defined three types of filter shapes according to an aspect of the disclosure. The three types of filter shapes (1001)-(1003) may include have fifteen inputs (also referred to as input samples) and generate one output. When the current block uses the EIP mode for prediction, the decoder may decode the relevant syntax elements to determine the selected type of reconstructed area and filter shape for the current block.

The selected filter may slide in the selected reconstructed area with a one-pixel step to collect input samples and output samples of the EIP mode. The auto-correlation matrix and cross-correlation vector may be constructed while removing the mean value from input samples and output samples. Then, the EIP coefficients may be obtained by the same method in CCCM.

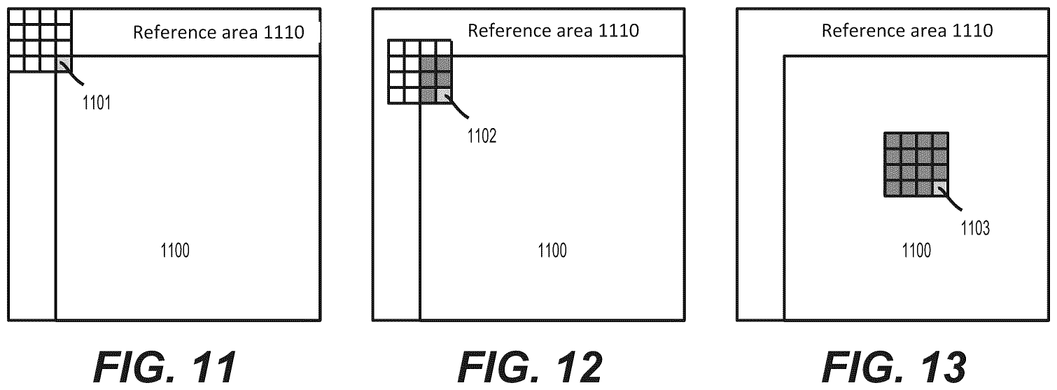

FIGS. 11-13 show an example of predicting samples in a current block (1100) based on the EIP mode according to an aspect of the disclosure. The EIP mode may predict samples in the current block position by position.

Referring to FIG. 11, all inputs to EIP are reconstructed samples. For the position (e.g., a top-left position) (1101) located at the top-left of the current block, the inputs to the EIP filter are reconstructed samples, for example, the reconstructed reference samples in the reference area (1110). Referring to FIG. 12, for the positions located along the boundaries of the current block (1100), partial inputs to the EIP filter are reference samples that are already reconstructed in the reference area (1110), and partial inputs to the EIP filter are previously predicted samples in the current block (1100). Referring to FIG. 13, all inputs to the EIP filter are predicted samples in the current block (1100), for example, for other positions in the current block (1100), the inputs to the EIP filter may include previously predicted samples in the current block (1100).

To reduce the prediction error, the searched min and max values may be applied to restrict the output range of each predicted value as described in Eq. 7.

$${pred}_{( x , y )} = clip ( min , max , ( {\sum }_{i = 0}^{n} ( {c}_{i} \times ( {t}_{( x - xoffset \_ i , y - yoffset \_ i )} - mean ) ) ) + mean ) \qquad Eq . 7$$

pred_{(x,y)} is the predicted value at (x, y) in the current block (1100), min, max are searched min and max values from, for example, the reference area (1110) (e.g., the thirteen reconstructed columns and rows), cᵢ represent the i^{th} coefficient of the derived EIP filter, t_{(x-xoffset_i,y-yoffset_i)} is reconstructed or predicted value used to predict the current position or the current sample, and mean is a mean value calculated by the DC prediction mode.

In some examples, such as in VVC, a variety of intra prediction modes are defined to generate the prediction value, such as the planar mode, the DC mode and angular intra prediction modes. A general intra prediction process may be described as the process of extrapolating a current sample from reference samples by Eq. 8.

$${pred}_{( x , y )} = {\sum }_{i = 0}^{n} ( {c}_{i} \times {ref}_{i} + bias ) \qquad Eq . 8$$

n is the number of reference samples, refᵢ is the i^{th} reference sample, and cᵢ is the filter coefficient for the i^{th} reference sample refᵢ. Given a specific intra prediction mode, the reference sample and the filter coefficients for a sample may be determined. In some examples, only the use of predefined filter coefficients is allowed, and the filter coefficients cannot be adjusted adaptively according to the video content. Further, a significant bit rate overhead is used to signal the selected intra prediction mode.

As described above, an extrapolation filter in the EIP mode may be derived from neighboring reconstructed samples of the current block and used to perform the intra prediction. Some examples of the extrapolation filter may not be accurate enough since it only consists of linear term of samples value and does not use the gradient information or include a nonlinear term.

Aspects of the disclosure provide techniques including improvement of the EIP mode, for example, by including at least one of gradient information, a nonlinear term, and/or the like as additional input(s) to the EIP filter. In an aspect, gradient information associated with a current sample in a current block may be determined. A nonlinear value (also interchangeably referred to as a nonlinear term) associated with the current sample may be determined from neighboring samples of the current sample based on a nonlinear relationship between the nonlinear value and values of the neighboring samples. A predicted value of the current sample may be determined based on an initial predicted value predicted using the EIP mode and additional information. The additional information may include at least one of the gradient information and the nonlinear value. The current sample may be coded from the predicted value of the current sample.

In an aspect, the intra prediction of the current block may be derived by utilizing the gradient information of, for example, neighboring reconstructed samples, such as gradients Gₓ and G_{y} of the neighboring reconstructed samples. A predicted value pred0(x, y) at (x, y) may be defined as:

$$pred 0 ( x , y ) = P 0 + GX + GY \qquad Eq . 9$$

$$P 0 = {\sum }_{i = 0}^{N 0} ( {c}_{0 , i} \times t ( x - {xoffset}_{0 , i} , y - {yoffset}_{0 , i} ) ) \qquad Eq . 10$$

$$GX = {\sum }_{j = 0}^{N 1} ( {c}_{1 , j} \times {G}_{x} ( x - {xoffset}_{1 , j} , y - {yoffset}_{1 , j} ) ) \qquad Eq . 11$$

$$GY = {\sum }_{k = 0}^{N 2} ( {c}_{2 , k} \times {G}_{y} ( x - {xoffset}_{2 , k} , y - {yoffset}_{2 , k} ) ) \qquad Eq . 12$$

pred0(x, y) is the predicted value at (x, y). (x, y) may be the position of the current sample. Three sets of parameters associated with P0, GX, and GY may correspond to input sample values, horizontal gradient information, and vertical gradient information, respectively. The gradient information may include the horizontal gradient information GX and the vertical gradient information GY.

The first set may be related to the input sample values, which may include parameters for N0 input samples. (x−xoffset_{0,i}, y−yoffset_{0,i}) is the position of the i^{th} input sample, c_{0,i} is the coefficient for the i^{th} input sample, and t (x−xoffset_{0,i}, y−yoffset_{0,i}) is the value for the i^{th} input sample.

In an example, N0 and the positions of the input samples are determined based on the filter (or the filter shape) used in the EIP mode to determine P0, such as shown in FIG. 10. N0 of the filter shape (1001)-(1003) is 15. NO may be different if a different filter is used.

The second set may be related to the horizontal gradient information, which may include parameters for N1 input sample(s). c_{1,j} is the coefficient for the j^{th} input sample, Gₓ(x−xoffset_{1,j}, y−yoffset_{1,j}) is the value of the horizontal gradient Gₓ for the j^{th} input sample. In an example, the N1 input sample(s) may be identical to the N0 input samples. In an example, the N1 input sample(s) may be different from the N0 input samples.

The third set may be related to the vertical gradient information, which may include parameters for N2 input sample(s). c_{2,k} is the coefficient for the k^{th} input sample, G_{y}(x−xoffset_{2,k}, y−yoffset_{2,k}) is the value of the vertical gradient G_{y} for the k^{th} input sample. In an example, the N2 input sample(s) may be identical to the N0 input samples. In an example, the N2 input sample(s) may be different from the N0 input samples. In an example, the N2 input sample(s) may be identical to the N1 input samples. In an example, the N2 input sample(s) may be different from the N1 input samples.

The N0 input samples, the N1 input samples, and the N2 input samples may include samples that are reconstructed samples and previously predicted samples. In the example shown in FIG. 11, the N0 input samples include the reconstructed samples in the reference area (1110), the N1 input samples, and the N2 input samples may also include the reconstructed samples in the reference area (1110).

In the example shown in FIG. 12, the N0 input samples include the reconstructed samples in the reference area (1110) and previously predicted samples (indicated by dark gray) in the current block (1100), and the N1 input samples and the N2 input samples may include the reconstructed samples in the reference area (1110) and/or previously predicted samples (indicated by dark gray) in the current block (1100).

In the example shown in FIG. 13, the N0 input samples, the N1 input samples, and the N2 input samples may include previously predicted samples (indicated by dark gray) in the current block (1100).

In an example, the gradient information (e.g., the horizontal gradient information GX and/or the vertical gradient information GY) associated with the current sample in the current block may be determined. The predicted value (e.g., pred0(x, y)) of the current sample may be determined based on an initial predicted value (e.g., P0) predicted using the EIP mode and additional information that includes the gradient information (e.g., GX and/or GY). The current sample may be coded from the predicted value of the current sample.

As described above, several variants of P0 may be used. For example, the mean removal operation can be applied to P0 when feeding the inputs (e.g., the NO input samples) to the EIP filter. P1 denotes the initial predicted value which may be P0 with the mean removal operation applied such as described in Eq. 13. Then the predicted value pred1(x, y) of (x, y) can be generated using Eqs. 13-14.

$$P 1 = ( {\sum }_{i = 0}^{N 0} ( {c}_{0 , i} \times ( t ( x - {xoffset}_{0 , i} , y - {yoffset}_{0 , i} ) - mean ) ) ) + mean \qquad Eq . 13$$

$$pred 1 ( x , y ) = P 1 + GX + GY \qquad Eq . 14$$

In an example, the clipping operation can be applied to generate the final prediction pred2 (x, y).

$$pred 2 ( x , y ) = clip ( min , max , Pi + GX + GY ) \qquad Eq . 15$$

The clipping operation may restrict the value of the final prediction pred2(x, y) to fall within a range from the min to the max.

The initial predicted value Pi in Eq. 15 may be P0, P1, or another variant of P0.

The gradient information may be obtained using any suitable methods, such as described below.

In an example when the gradient information includes horizontal gradient information (e.g., GX), a number (e.g., N1) of first input samples used to determine the horizontal gradient information and positions (e.g., indicated by (x−xoffset_{0,j}, y−yoffset_{0,j}) in Eq. 11) of the first input samples are set independently, for example, from a number (e.g. NO) and positions (e.g., indicated by (x-xoffset_{0,i}, y-yoffset_{0,i}) in Eq. 10) of input samples used to determine the initial predicted value (e.g., P0 or P1). When the gradient information includes vertical gradient information (e.g., GY), a number (e.g., N2) of second input samples used to determine the vertical gradient information and positions (e.g., indicated by (x−xoffset_{0,k}, y−yoffset_{0,k}) in Eq. 12) of the second input samples are set independently, for example, from the number and the positions of the input samples used to determine the initial predicted value. When the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value, such as described below.

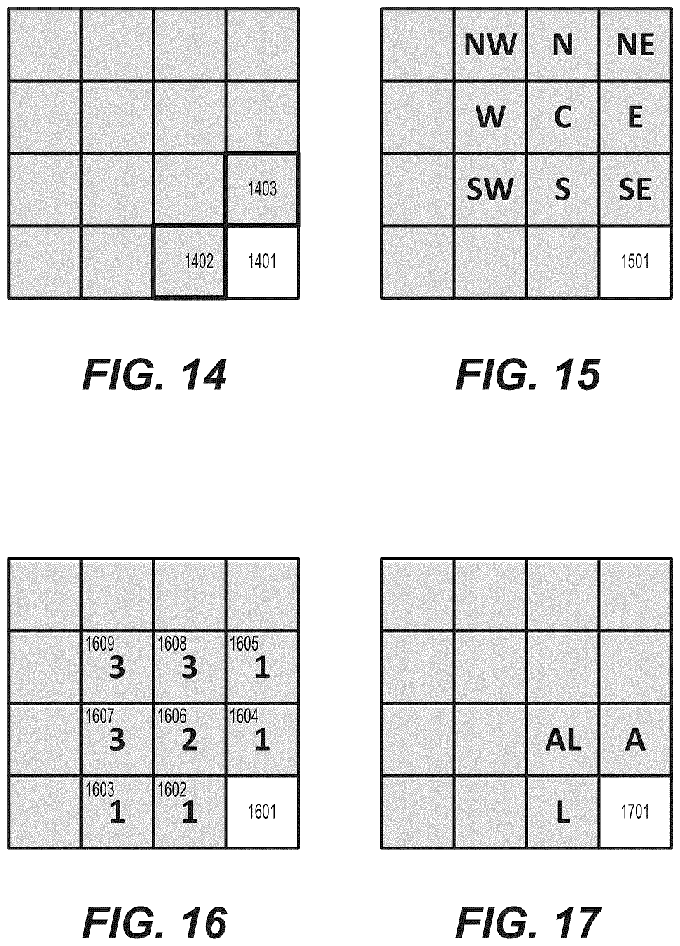

The number and positions for different set of parameters can be set independently. FIG. 14 shows an example of input samples used in the EIP filter according to an aspect of the disclosure. Referring to FIG. 14, in an example, the values of 15 gray samples (including (1402)-(1403)) may be used as inputs to the EIP filter (e.g., Eqs. 9-10 or Eqs. 13-14) to generate P0 or P1 for a current sample (1401), and thus NO is 15. To generate the gradient information, such as GX and GY, the samples (1402)-(1403) may be used as the input to the EIP filter (e.g., Eqs. 9, 11, and 12), and thus N1 and N2 are 2. The EIP filter may include a spatial filter described in Eq. 10 that generates P0 (or a variant such as P1) and gradient filters described in Eqs. 10-11 that generates GX and GY, respectively. In an example, the values of 15 gray samples may be available to the EIP filter, only a subset (1402)-(1403) may be used in the actual process.

In an aspect, the gradient information includes a sum of the horizontal gradient information and the vertical gradient information. The number (e.g., N1) of the first input samples (also referred to as the N1 input samples) is equal to the number (e.g., N2) of the second input samples (also referred to as the N2 input samples), e.g., N1=N2.

In one aspect, both GX and GY can be generated using the N1 input samples and the N2 input samples to the EIP filter, respectively. N1 may be equal to N2, and the same sample positions may be used as the input for GX and GY (e.g., to generate GX and GY). An example is shown in FIGS. 14, N1 and N2 are 2, the same sample positions (1402)-(1403) are used as the N1 input samples to generate GX and as the N2 input samples to generate GY.

In one aspect, both GX and GY can be generated using the N1 input samples and the N2 input samples to the EIP filter, respectively. N1 is equal to N2. Different sample positions are used as the input for GX and GY. Referring to FIGS. 14, N1 and N2 is 1, the sample (1402) is used to generate GX, and the sample (1403) is used to generate GY.

In one aspect, GX is generated using the N1 input samples and only GX is included in the EIP filter such as shown in Eq. 16. For example, only Gₓ may be used as the input to the EIP filter. In this example, the gradient information consists of the horizontal gradient information, and N2 is 0.

$$pred 0 ( x , y ) = P 0 + GX \qquad Eq . 16$$

In one aspect, GY is generated using the N2 input samples and only GY is included in the EIP filter such as shown in Eq. 17. For example, only G_{y} may be used as the input to the EIP filter. In this example, the gradient information consists of the vertical gradient information, and N1 is 0.

$$pred 0 ( x , y ) = P 0 + GY \qquad Eq . 17$$

In an aspect, one of (i) the number (N1) of the first input samples (the N1 input samples) used to determine the horizontal gradient information of the gradient information or positions of the first input samples and (ii) the number (N2) of the second input samples (the N2 input samples) used to determine vertical gradient information of the gradient information or positions of the second input samples depends on the block shape of the current block or the filter shape (e.g., one of (1001)-(1003) shown in FIG. 10) of the EIP mode.

In one aspect, the numbers (e.g., N1 and N2) or positions of input samples for the gradient information may depend on a block shape. For example, N1 or the N1 positions of the N1 input samples for the horizontal gradient information may depend on the block shape. For example, N2 or the N2 positions of the N2 input samples for the vertical gradient information may depend on the block shape.

In one example, if the block shape is rectangular with a width≤a height or vice versa (e.g., with a height≤a width), the numbers (e.g., N1 and/or N2) or positions of input samples (e.g., the N1 input samples and/or the N2 input samples) for generating the gradient information may be adjusted to align with the block dimensions. In an example, if the block width i≤the block height, N1 is ≤N2.

In one aspect, the number or position of input samples for the gradient information may depend on the filter shape. For example, N1 or the N1 positions of the N1 input samples for the horizontal gradient information may depend on the filter shape. For example, N2 or the N2 positions of the N2 input samples for the vertical gradient information may depend on the filter shape. Some examples of the filter shapes are shown in FIG. 10.

In one example, if the filter shape is rectangular such as the filter shape (1002) or (1003) shown in FIG. 10, the number or position of input samples for generating gradient information may be adjusted to align with the filter shape.

The gradient information may be determined based on at least one of the horizontal gradient information (GX) that is determined based on horizontal gradients (Gₓ) of the respective first input samples or the vertical gradient information (GY) that is determined based on vertical gradients G_{y} of the respective second input samples, such as shown in Eqs. 9, 11, and 12.

A gradient associated with an input sample such as a horizontal gradient Gₓ or a vertical gradient G_{y} may be calculated using any sutiable method. Some examples are described below.

FIG. 15 shows an example of spatial samples of an input sample C used for calculating the gradient information according to an aspect of the disclosure. In an example, the EIP filter is applied to a current sample (1501). Given the input sample C and neighboring samples (e.g., indicated using “N”, “S”, “E”, “W”, “NW”, “NE”, “SW”, and “SE”) of the input sample C, the individual gradient such as Gₓ and G_{y} may be calculated as below.

In an aspect, Gₓ and G_{y} may be calcuated based on the samples C, W, and N.

$${G}_{y} = ( C - N ) \qquad Eq . 18$$

$${G}_{x} = ( C - W )$$

In an aspect, Gₓ and G_{y} may be calcuated based on the samples N, S, W, and E.

$${G}_{y} = ( N - S ) \qquad Eq . 19$$

$${G}_{x} = ( W - E )$$

In an aspect, Gₓ and G_{y} may be calcuated based N, S, W, E, NW, SW, NE, and SE.

$${G}_{y} = ( 2 N + NW + NE ) - ( 2 S + SW + SE ) \qquad Eq . 20$$

$${G}_{x} = ( 2 W + NW + SW ) - ( 2 E + NE + SE )$$

In an example, the input sample C is one of the first input samples (e.g., the N1 input samples). The horizontal gradient Gₓ of the one of the first input samples may be determined based on: (i) a difference between the one of the first input samples and a left neighbor (e.g., W) of the one of the first input samples, such as shown in Eq. 18; (ii) a difference between the left neighbor of the one of the first input samples and a right neighbor (e.g., E) of the one of the first input samples, such as shown in Eq. 19; and (iii) a difference between a first value and a second value, such as shown in Eq. 20. The first value (e.g., (2W+NW+SW)) may be a sum (e.g., a weighted sum) based on a top-left neighbor (e.g., NW), the left neighbor (e.g., W), and a bottom-left neighbor (e.g., SW) of the one of the first input samples, and the second value (e.g., (2E+NE+SE)) may be a sum (e.g., a weighted sum) based on a top-right neighbor (e.g., NE), the right neighbor (e.g., E), and a bottom-right neighbor (e.g., SE) of the one of the first input samples. In an example, which of the differences is used to calculate the horizontal gradient of the one of the first input samples may be determined based on a position of the one of the first input samples.

In an example, the input sample C is one of the second input samples (e.g., the N2 input samples). The vertical gradient G_{y} of the one of the second input samples may be determined based on: (i) a difference between the one of the second input samples and a top neighbor (e.g., N) of the one of the second input samples, such as shown in Eq. 18; (ii) a difference between the top neighbor of the one of the second input samples and a bottom neighbor (e.g., S) of the one of the second input samples, such as shown in Eq. 19; and (iii) a difference between a first value and a second value, such as shown in Eq. 20. The first value (e.g., (2N+NW+NE)) used to calculate G_{y} may be a sum (e.g., a weighted sum) based on a top-left neighbor (e.g., NW), the top neighbor (e.g., N), and a top-right neighbor (e.g., NE) of the one of the second input samples, and the second value (e.g., (2S+SW+SE)) may be a sum (e.g., a weighted sum) based on a bottom-left neighbor (e.g., SW), the bottom neighbor (e.g., S), and a bottom-right neighbor (e.g., SE) of the one of the second input samples. In an example, which of the differences is used to calculate the vertical gradient G_{y} of the one of the second input samples may be determined based on a position of the one of the second input samples.

In an aspect, Gₓ and G_{y} may be calcuated depending on a position of the input sample C. FIG. 16 shows an example of choosing a gradient calculation method (e.g., one of the methods descrbed with Eqs. 18-20) based on the location of the input sample according to an aspect of the disclosure. The gradients {Gₓ, G_{y}} of eight input samples (1602)-(1609) may be calculated using different gradient calculation methods depending on the locations of the eight input samples (1602)-(1609). The input samples (1602)-(1605) are located at a type 1 location. For each of the input samples (1602)-(1605) at the type 1 location, the samples C, W, and N for the respective input sample may be used to calculate Gₓ and G_{y} for the input sample, for example, using Eq. 18. For example, the samples C, W, and N for the input sample (1602) are the samples (1602), (1603), and (1606), respectively. For example, the samples C, W, and N for the input sample (1604) are the samples (1604), (1606), and (1605), respectively. The input sample (1606) is located at a type 2 location. The samples N, S, W, and E may be used to calculate G and G_{y} for the input sample (1606) at the type 2 location, for example, using Eq. 19. The input samples (1607)-(1609) are located at a type 3 location. For each of the input samples (1607)-(1609) at the type 3 location, the samples N, S, W, E, NW, SW, NE, and SE for the respective input sample may be used to calculate Gₓ and G_{y} for the input sample, for example, using Eq. 20.

In an aspect, the intra prediction of current block may be derived by utilizing a nonlinear term derived from the neighboring reconstructed samples.

In an aspect, the predicted value such as pred1(x, y) or pred (x, y) (e.g., pred0(x, y)) can be further refined using a nonlinear term (also referred to as a nonlinear value NP). The nonlinear term may be generated from reconstructed or previously predicted values, for example, in the immediate neighborhood of the current sample (e.g., the current predicted sample).

In an example, the refined prediction p̅r̅e̅d̅_̅ι̅(̅x̅,̅ y̅)̅ may be obtained based on the predicted value predi(x, y) (e.g., pred0(x, y), pred1(x, y), or the like) and the nonlinear term using Eq. 21.

$$\overline{pred\_ι ( x , y )} = predi ( x , y ) + {c}_{nonlinear} NP \qquad Eq .$$

cₙₒₙₗᵢₙₑₐᵣ is a coefficient for the nonlinear term. The nonlinear term NP may be defined using Eq. 22.

$$NP = ( M \times M + midVal ) >> bitDepth \qquad Eq .$$

M may be determined based on a mean value (M=mean(A, L, AL)) or a median value (M=median(A, L, AL)) of the neighboring samples A, L, and AL of the current sample. FIG. 17 shows an example of the locations of the A, L, and AL samples. The A, L, and AL samples are neighboring samples of the current sample (1701).

In an example, the middle value (midVal) for 10-bit content is 2¹⁰/2, which is 512. Thus, for 10-bit content the nonlinear term NP may be calculated as using Eq. 23.

$$NP = ( M \times M + 5 \; 12 ) >> 10 \qquad Eq . 23$$

The clipping operation can be applied to p̅r̅e̅d̅_̅ι̅(̅x̅,̅ y̅)̅ to generate the final prediction pred2(x, y) using Eq. 24.

$$pred 2 ( x , y ) = clip ( min , max , \overline{pred\_ι ( x , y )} ) \qquad Eq . 24$$

In an example, the nonlinear value associated with the current sample may be determined from the neighboring samples (e.g., the A, L, and AL samples in FIG. 17) of the current sample (e.g., (1701)) based on a nonlinear relationship (e.g., a quadratic relationship) between the nonlinear value NP and values of the neighboring samples such as described in Eq. 22. The predicted value of the current sample may be determined from the initial predicted value predicted using the EIP mode and the additional information that includes the gradient information and the nonlinear value such as shown in Eq. 21. For example, predi(x, y) (e.g., pred0(x, y) or pred1(x, y)) can include the initial predicted value (e.g., P0 or P1) predicted using the EIP mode and the gradient information (e.g., GX and/or GY). In an example, referring to FIG. 17, a first value (e.g., M in Eq. 22) that is one of a mean or a median of a top-left neighbor (AL), a top neighbor (A), and a left neighbor (L) of the current sample (1701) is calculated, and the nonlinear value is determined based on the first value squared (e.g., M²).

In an aspect, the predicted value of the current sample predicted using the EIP mode is determined based on the initial predicted value Pi (e.g., calculated using Eq. 10, Eq. 13, or the like) and at least one of: GX (e.g., calculated using Eq. 11), GY (e.g., calculated using Eq. 12), and a nonlinear term NP (e.g., calculated using Eq. 22). In some examples, the predicted value of the current sample may be clipped.

The EIP filter may include different sets of coefficients, such as the first set (e.g., c_{0,i} in Eq. 10 or 13 related to the N0 input samples with or without the mean removal operation), the second set related to GX (e.g., c_{1,j} in Eq. 11), the third set related to GY (e.g., c_{2,k} in Eq. 12), cₙₒₙₗᵢₙₑₐᵣ related to the nonlinear term, and the like. When additional set(s) of coefficients are included in the EIP filter, the filter coefficients in the EIP filter may be obtained from the neighboring reconstructed pixels (or samples) of the current block with a pre-determined template, similarly or identical to that described in FIG. 7. For example, if Eq. 9 is used to calculate the predicted value pred0(x, y), the EIP filter includes the first set of coefficients {c_{0,i}}, the second set of coefficients {c_{1,j}}, and the third set of coefficients {c_{2,k}}, and thus {c_{0,i}}, {c_{1,j}}, and {c_{2,k}} may be obtained from the neighboring reconstructed pixels (or samples) of the current block with the pre-determined template.

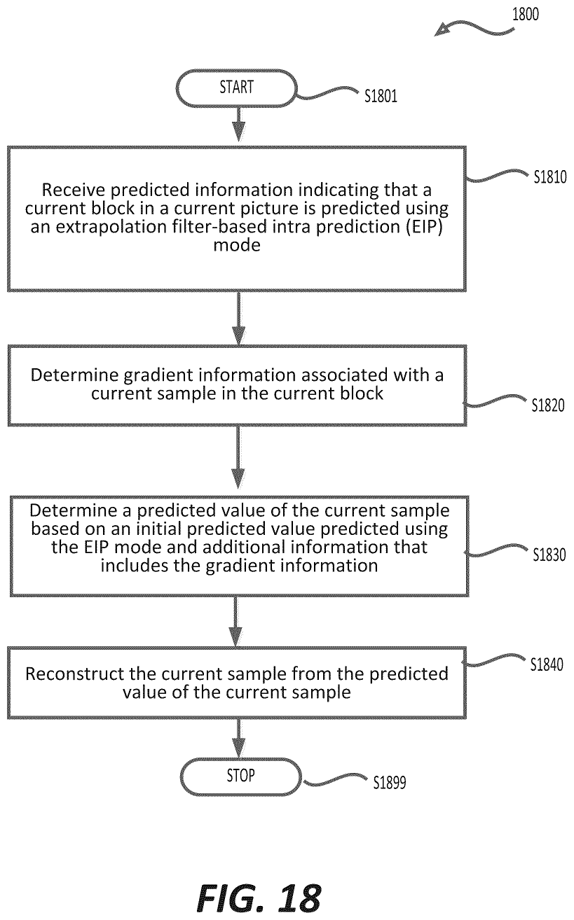

FIG. 18 shows a flow chart outlining a process (1800) according to an aspect of the disclosure. The process (1800) can be used in a video decoder. In various aspects, the process (1800) is executed by processing circuitry, such as the processing circuitry that performs functions of the video decoder (110), the processing circuitry that performs functions of the video decoder (210), and the like. In some aspects, the process (1800) is implemented in software instructions, thus when the processing circuitry executes the software instructions, the processing circuitry performs the process (1800). The process starts at (S1801) and proceeds to (S1810).

At (S1810), predicted information indicating that a current block in a current picture is predicted using an extrapolation filter-based intra prediction (EIP) mode is received.

At (S1820), gradient information associated with a current sample in the current block is determined.

In an example, when the gradient information includes horizontal gradient information, a number of first input samples used to determine the horizontal gradient information and positions of the first input samples are set independently from a number and positions of input samples used to determine the initial predicted value. When the gradient information includes vertical gradient information, a number of second input samples used to determine the vertical gradient information and positions of the second input samples are set independently from the number and the positions of the input samples used to determine the initial predicted value. When the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value.

In an example, the gradient information includes a sum of the horizontal gradient information and the vertical gradient information and the number of the first input samples is equal to the number of the second input samples.

In an example, one of (i) a number of first input samples used to determine horizontal gradient information of the gradient information or positions of the first input samples and (ii) a number of second input samples used to determine vertical gradient information of the gradient information or positions of the second input samples depends on a block shape of the current block or a filter shape of the EIP mode.

In an example, the gradient information is determined based on at least one of the horizontal gradient information that is determined based on horizontal gradients of the respective first input samples or the vertical gradient information that is determined based on vertical gradients of the respective second input samples.

In an example, a horizontal gradient of one of the first input samples is determined based on: (i) a difference between the one of the first input samples and a left neighbor of the one of the first input samples; (ii) a difference between the left neighbor of the one of the first input samples and a right neighbor of the one of the first input samples; and (iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples. Which of the differences is used to calculate the horizontal gradient of the one of the first input samples is determined based on a position of the one of the first input samples.

In an example, a vertical gradient of one of the second input samples is determined based on: (i) a difference between the one of the second input samples and a top neighbor of the one of the second input samples; (ii) a difference between the top neighbor of the one of the second input samples and a bottom neighbor of the one of the second input samples; and (iii) a difference between a first value and a second value, the first value being a sum based on a top-left neighbor, the top neighbor, and a top-right neighbor of the one of the second input samples, the second value being a sum based on a bottom-left neighbor, the bottom neighbor, and a bottom-right neighbor of the one of the second input samples. Which of the differences is used to calculate the vertical gradient of the one of the second input samples is determined based on a position of the one of the second input samples.

At (S1830), a predicted value of the current sample is determined based on an initial predicted value predicted using the EIP mode and additional information that includes the gradient information.

At (S1840), reconstruct the current sample from the predicted value of the current sample.

Then, the process proceeds to (S1899) and terminates.

The process (1800) can be suitably adapted. Step(s) in the process (1800) can be modified and/or omitted. Additional step(s) can be added. Any suitable order of implementation can be used.

In an example, a nonlinear value associated with the current sample is determined from neighboring samples of the current sample based on a nonlinear relationship between the nonlinear value and values of the neighboring samples and the predicted value of the current sample is determined from the initial predicted value predicted using the EIP mode and the additional information that includes the gradient information and the nonlinear value.

In an example, a first value that is one of a mean or a median of a top-left neighbor, a top neighbor, and a left neighbor of the current sample is calculated and the nonlinear value is determined based on the first value squared.

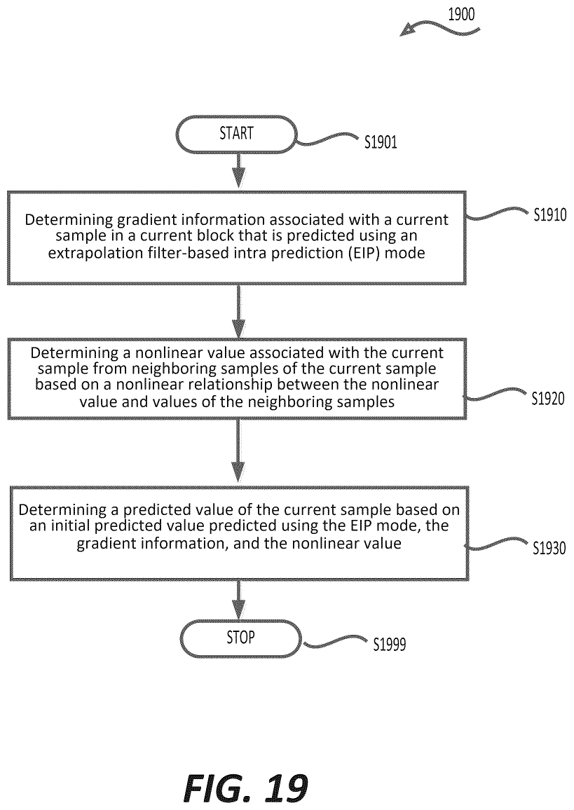

FIG. 19 shows a flow chart outlining a process (1900) according to an aspect of the disclosure. The process (1900) can be used in a video encoder. In various aspects, the process (1900) is executed by processing circuitry, such as the processing circuitry that performs functions of the video encoder (103), the processing circuitry that performs functions of the video encoder (303), and the like. In some aspects, the process (1900) is implemented in software instructions, thus when the processing circuitry executes the software instructions, the processing circuitry performs the process (1900). The process starts at (S1901) and proceeds to (S1910).

At (S1910), gradient information associated with a current sample in a current block is determined. The current block is predicted using an extrapolation filter-based intra prediction (EIP) mode.

In an example, when the gradient information includes horizontal gradient information, a number of first input samples used to determine the horizontal gradient information and positions of the first input samples are set independently from a number and positions of input samples used to determine the initial predicted value. When the gradient information includes vertical gradient information, a number of second input samples used to determine the vertical gradient information and positions of the second input samples are set independently from the number and the positions of the input samples used to determine the initial predicted value. When the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value.

In an example, the gradient information includes a sum of the horizontal gradient information and the vertical gradient information, and the number of the first input samples is equal to the number of the second input samples.

In an example, one of (i) a number of first input samples used to determine horizontal gradient information of the gradient information or positions of the first input samples and (ii) a number of second input samples used to determine vertical gradient information of the gradient information or positions of the second input samples depends on a block shape of the current block or a filter shape of the EIP mode.

In an example, the gradient information is determined based on at least one of the horizontal gradient information that is determined based on horizontal gradients of the respective first input samples or the vertical gradient information that is determined based on vertical gradients of the respective second input samples.

In an example, a horizontal gradient of one of the first input samples is determined based on: (i) a difference between the one of the first input samples and a left neighbor of the one of the first input samples; (ii) a difference between the left neighbor of the one of the first input samples and a right neighbor of the one of the first input samples; and (iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples. Which of the differences is used to calculate the horizontal gradient of the one of the first input samples is determined based on a position of the one of the first input samples.

In an example, a vertical gradient of one of the second input samples is determined based on: (i) a difference between the one of the second input samples and a top neighbor of the one of the second input samples; (ii) a difference between the top neighbor of the one of the second input samples and a bottom neighbor of the one of the second input samples; and (iii) a difference between a first value and a second value, the first value being a sum based on a top-left neighbor, the top neighbor, and a top-right neighbor of the one of the second input samples, the second value being a sum based on bottom-left neighbor, the bottom neighbor, and a bottom-right neighbor of the one of the second input samples. Which of the differences is used to calculate the vertical gradient of the one of the second input samples is determined based on a position of the one of the second input samples.

At (S1920), a nonlinear value associated with the current sample is determined from neighboring samples of the current sample based on a nonlinear relationship between the nonlinear value and values of the neighboring samples.

At (S1930), a predicted value of the current sample is determined based on an initial predicted value predicted using the EIP mode, the gradient information, and the nonlinear value.

Then, the process proceeds to (S1999) and terminates.

The process (1900) can be suitably adapted. Step(s) in the process (1900) can be modified and/or omitted. Additional step(s) can be added. Any suitable order of implementation can be used.

In an aspect, a method of processing visual media data is disclosed. The method comprises performing a conversion between a visual media file and a bitstream of visual media data according to a format rule. The bitstream includes prediction information indicating that a current block in a current picture is predicted using an extrapolation filter-based intra prediction (EIP) mode. The format rule specifies that: gradient information associated with a current sample in the current block that is predicted using the EIP mode is determined; a nonlinear value associated with the current sample is determined from neighboring samples of the current sample using a nonlinear relationship between the nonlinear value and values of the neighboring samples; a predicted value of the current sample is determined from an initial predicted value predicted based on the EIP mode, the gradient information, and the nonlinear value; when the gradient information includes horizontal gradient information, a number of first input samples used to determine the horizontal gradient information and positions of the first input samples are set independently from a number and positions of input samples used to determine the initial predicted value; when the gradient information includes vertical gradient information, a number of second input samples used to determine the vertical gradient information and positions of the second input samples are set independently from the number and the positions of the input samples used to determine the initial predicted value; and when the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value, respectively.

In an example, the gradient information includes a sum of the horizontal gradient information and the vertical gradient information, and the number of the first input samples is equal to the number of the second input samples.

In an example, one of (i) the number of the first input samples used to determine the horizontal gradient information of the gradient information or the positions of the first input samples and (ii) the number of the second input samples used to determine the vertical gradient information of the gradient information or the positions of the second input samples depends on a block shape of the current block or a filter shape of the EIP mode.

In an example, the determining the gradient information comprises determining the gradient information based on at least one of (i) the horizontal gradient information that is determined based on horizontal gradients of the respective first input samples and (ii) the vertical gradient information that is determined based on vertical gradients of the respective second input samples.

In an example, a horizontal gradient of one of the first input samples is determined based on: (i) a difference between the one of the first input samples and a left neighbor of the one of the first input samples; (ii) a difference between the left neighbor of the one of the first input samples and a right neighbor of the one of the first input samples; and (iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples.

In an example, which of the differences is used to calculate the horizontal gradient of the one of the first input samples is determined based on a position of the one of the first input samples.

In an example, a vertical gradient of one of the second input samples is determined based on: (i) a difference between the one of the second input samples and a top neighbor of the one of the second input samples; (ii) a difference between the top neighbor of the one of the second input samples and a bottom neighbor of the one of the second input samples; and (iii) a difference between a first value and a second value, the first value being a sum based on a top-left neighbor, the top neighbor, and a top-right neighbor of the one of the second input samples, the second value being a sum based on bottom-left neighbor, the bottom neighbor, and a bottom-right neighbor of the one of the second input samples.

In an example, which of the differences is used to calculate the vertical gradient of the one of the second input samples is determined based on a position of the one of the second input samples.

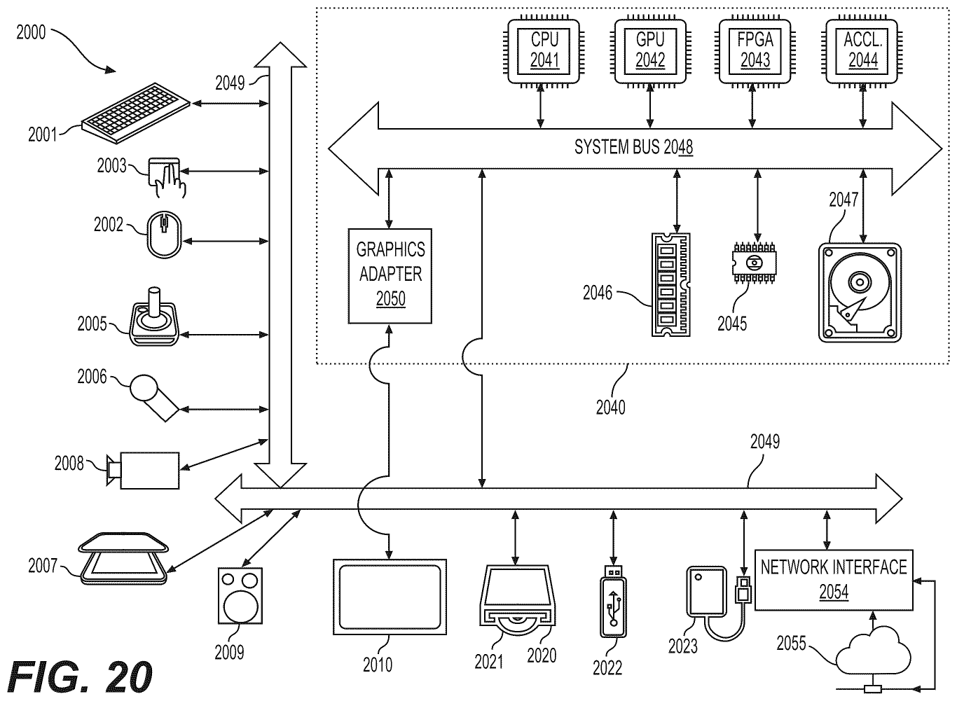

The techniques described above, can be implemented as computer software using computer-readable instructions and physically stored in one or more computer-readable media. For example, FIG. 20 shows a computer system (2000) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 20 for computer system (2000) are exemplary in nature and are not intended to suggest any limitation as to the scope of use or functionality of the computer software implementing aspects of the present disclosure. Neither should the configuration of components be interpreted as having any dependency or requirement relating to any one or combination of components illustrated in the exemplary aspect of a computer system (2000).

Computer system (2000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2001), mouse (2002), trackpad (2003), touch screen (2010), data-glove (not shown), joystick (2005), microphone (2006), scanner (2007), camera (2008).

Computer system (2000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2010), data-glove (not shown), or joystick (2005), but there can also be tactile feedback devices that do not serve as input devices), audio output devices (such as: speakers (2009), headphones (not depicted)), visual output devices (such as screens (2010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2000) can also include human accessible storage devices and their associated media such as optical media including CD/DVD ROM/RW (2020) with CD/DVD or the like media (2021), thumb-drive (2022), removable hard drive or solid state drive (2023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2000) can also include an interface (2054) to one or more communication networks (2055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2049) (such as, for example USB ports of the computer system (2000)); others are commonly integrated into the core of the computer system (2000) by attachment to a system bus as described below (for example Ethernet interface into a PC computer system or cellular network interface into a smartphone computer system). Using any of these networks, computer system (2000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2040) of the computer system (2000).

The core (2040) can include one or more Central Processing Units (CPU) (2041), Graphics Processing Units (GPU) (2042), specialized programmable processing units in the form of Field Programmable Gate Areas (FPGA) (2043), hardware accelerators for certain tasks (2044), graphics adapters (2050), and so forth. These devices, along with Read-only memory (ROM) (2045), Random-access memory (2046), internal mass storage such as internal non-user accessible hard drives, SSDs, and the like (2047), may be connected through a system bus (2048). In some computer systems, the system bus (2048) can be accessible in the form of one or more physical plugs to enable extensions by additional CPUs, GPU, and the like. The peripheral devices can be attached either directly to the core's system bus (2048), or through a peripheral bus (2049). In an example, the screen (2010) can be connected to the graphics adapter (2050). Architectures for a peripheral bus include PCI, USB, and the like.

CPUs (2041), GPUs (2042), FPGAs (2043), and accelerators (2044) can execute certain instructions that, in combination, can make up the aforementioned computer code. That computer code can be stored in ROM (2045) or RAM (2046). Transitional data can also be stored in RAM (2046), whereas permanent data can be stored for example, in the internal mass storage (2047). Fast storage and retrieve to any of the memory devices can be enabled through the use of cache memory, that can be closely associated with one or more CPU (2041), GPU (2042), mass storage (2047), ROM (2045), RAM (2046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2000), and specifically the core (2040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2040) that are of non-transitory nature, such as core-internal mass storage (2047) or ROM (2045). The software implementing various aspects of the present disclosure can be stored in such devices and executed by core (2040). A computer-readable medium can include one or more memory devices or chips, according to particular needs. The software can cause the core (2040) and specifically the processors therein (including CPU, GPU, FPGA, and the like) to execute particular processes or particular parts of particular processes described herein, including defining data structures stored in RAM (2046) and modifying such data structures according to the processes defined by the software. In addition or as an alternative, the computer system can provide functionality as a result of logic hardwired or otherwise embodied in a circuit (for example: accelerator (2044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
receive predicted information indicating that a current block in a current picture is predicted using an extrapolation filter-based intra prediction (EIP) mode;
determine gradient information associated with a current sample in the current block;
determine a predicted value of the current sample based on an initial predicted value predicted using the EIP mode and additional information that includes the gradient information; and
reconstruct the current sample from the predicted value of the current sample.

2. The apparatus of claim 1, wherein the processing circuitry is configured to:
determine a nonlinear value associated with the current sample from neighboring samples of the current sample based on a nonlinear relationship between the nonlinear value and values of the neighboring samples; and
determine the predicted value of the current sample from the initial predicted value predicted using the EIP mode and the additional information that includes the gradient information and the nonlinear value.

3. The apparatus of claim 1, wherein
when the gradient information includes horizontal gradient information, a number of first input samples used to determine the horizontal gradient information and positions of the first input samples are set independently from a number and positions of input samples used to determine the initial predicted value;
when the gradient information includes vertical gradient information, a number of second input samples used to determine the vertical gradient information and positions of the second input samples are set independently from the number and the positions of the input samples used to determine the initial predicted value; and
when the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value.

4. The apparatus of claim 3, wherein
the gradient information includes a sum of the horizontal gradient information and the vertical gradient information; and
the number of the first input samples is equal to the number of the second input samples.

5. The apparatus of claim 1, wherein one of (i) a number of first input samples used to determine horizontal gradient information of the gradient information or positions of the first input samples and (ii) a number of second input samples used to determine vertical gradient information of the gradient information or positions of the second input samples depends on a block shape of the current block or a filter shape of the EIP mode.

6. The apparatus of claim 1, wherein the processing circuitry is configured to determine the gradient information based on at least one of horizontal gradient information that is determined based on horizontal gradients of respective first input samples or vertical gradient information that is determined based on vertical gradients of respective second input samples.

7. The apparatus of claim 6, wherein the processing circuitry is configured to:
determine a horizontal gradient of one of the first input samples based on:
(i) a difference between the one of the first input samples and a left neighbor of the one of the first input samples;
(ii) a difference between the left neighbor of the one of the first input samples and a right neighbor of the one of the first input samples; and
(iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples.

8. The apparatus of claim 7, wherein the processing circuitry is configured to:
determine which of the differences is used to calculate the horizontal gradient of the one of the first input samples based on a position of the one of the first input samples.

9. The apparatus of claim 6, wherein the processing circuitry is configured to:
determine a vertical gradient of one of the second input samples based on:
(i) a difference between the one of the second input samples and a top neighbor of the one of the second input samples;
(ii) a difference between the top neighbor of the one of the second input samples and a bottom neighbor of the one of the second input samples; and
(iii) a difference between a first value and a second value, the first value being a sum based on a top-left neighbor, the top neighbor, and a top-right neighbor of the one of the second input samples, the second value being a sum based on a bottom-left neighbor, the bottom neighbor, and a bottom-right neighbor of the one of the second input samples.

10. The apparatus of claim 9, wherein the processing circuitry is configured to:
determine which of the differences is used to calculate the vertical gradient of the one of the second input samples based on a position of the one of the second input samples.

11. The apparatus of claim 2, wherein the processing circuitry is configured to:
calculate a first value that is one of a mean or a median of a top-left neighbor, a top neighbor, and a left neighbor of the current sample; and
determine the nonlinear value based on the first value squared.

12. A method for video encoding, comprising:
determining gradient information associated with a current sample in a current block that is predicted using an extrapolation filter-based intra prediction (EIP) mode;
determining a predicted value of the current sample based on an initial predicted value predicted using the EIP mode and additional information that includes the gradient information; and
encoding the current sample from the predicted value of the current sample.

13. The method of claim 12, wherein
the method includes determining a nonlinear value associated with the current sample from neighboring samples of the current sample based on a nonlinear relationship between the nonlinear value and values of the neighboring samples; and
the determining the predicted value includes determining the predicted value of the current sample from the initial predicted value predicted using the EIP mode and the additional information that includes the gradient information and the nonlinear value.

14. The method of claim 12, wherein
when the gradient information includes horizontal gradient information, a number of first input samples used to determine the horizontal gradient information and positions of the first input samples are set independently from a number and positions of input samples used to determine the initial predicted value;
when the gradient information includes vertical gradient information, a number of second input samples used to determine the vertical gradient information and positions of the second input samples are set independently from the number and the positions of the input samples used to determine the initial predicted value; and
when the gradient information includes both the horizontal gradient information and the vertical gradient information, (i) the number and the positions of the first input samples and (ii) the number and the positions of the second input samples are set independently from each other and from the number and the positions of the input samples used to determine the initial predicted value.

15. The method of claim 14, wherein
the gradient information includes a sum of the horizontal gradient information and the vertical gradient information; and
the number of the first input samples is equal to the number of the second input samples.

16. The method of claim 12, wherein one of (i) a number of first input samples used to determine horizontal gradient information of the gradient information or positions of the first input samples and (ii) a number of second input samples used to determine vertical gradient information of the gradient information or positions of the second input samples depends on a block shape of the current block or a filter shape of the EIP mode.

17. The method of claim 12, wherein the determining the gradient information includes determining the gradient information based on at least one of horizontal gradient information that is determined based on horizontal gradients of respective first input samples or vertical gradient information that is determined based on vertical gradients of respective second input samples.

18. The method of claim 17, wherein the determining the gradient information includes
determining a horizontal gradient of one of the first input samples based on:
(i) a difference between the one of the first input samples and a left neighbor of the one of the first input samples;
(ii) a difference between the left neighbor of the one of the first input samples and a right neighbor of the one of the first input samples; and
(iii) a difference between a first value and a second value, the first value being a sum based on a top-left neighbor, the left neighbor, and a bottom-left neighbor of the one of the first input samples, the second value being a sum based on a top-right neighbor, the right neighbor, and a bottom-right neighbor of the one of the first input samples.

19. The method of claim 13, wherein the determining the nonlinear value includes
calculating a first value that is one of a mean or a median of a top-left neighbor, a top neighbor, and a left neighbor of the current sample; and
determining the nonlinear value based on the first value squared.

20. A non-transitory computer readable medium storing a video media bitstream encoded by an encoding method, the encoding method comprising:
determining gradient information associated with a current sample in a current block that is predicted using an extrapolation filter-based intra prediction (EIP) mode;
determining a predicted value of the current sample based on an initial predicted value predicted using the EIP mode and additional information that includes the gradient information; and
encoding the current sample from the predicted value of the current sample.
